(19) United States
(12) Patent Application Publication
(10) Pub. No.: US 2007/0105038 A1
(43) Pub. Date: May 10, 2007

(54) Positive resist composition and method for forming resist pattern

(76) Inventors: Masaru Takeshita, Kawasaki-shi (JP); Ryotaro Hayashi, Kawasaki-shi (JP); Takeshi Iwai, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/580,768

(22) PCT Filed: Nov. 24, 2004
(86) PCT No.: PCT/JP04/17405

§ 371 Date: May 25, 2006

(30) Foreign Application Priority Data
Nov. 28, 2003 (JP) 2003-399663

(51) Int. Cl. G03C 1/00

(52) U.S. Cl. 430/270.1

(57) ABSTRACT

A positive resist composition that includes a base resin component (A) and an acid generator component (B), wherein the component (A) is a copolymer that includes structural units (a-1), which are derived from an (α-lower alkyl) acrylate ester that contains an acid dissociable, dissolution inhibiting group, and also contains an aliphatic cyclic group, structural units (a-2), which are derived from an (α-lower alkyl) acrylate ester that contains a γ-butyrolactone residue, and structural units (a-3), which are derived from an (α-lower alkyl) acrylate ester that contains a hydroxyl group-containing aliphatic polycyclic hydrocarbon group, and the glass transition temperature (Tg) of the copolymer is within a range from 100 to 170° C.; together with a method for forming a resist pattern using a lithography process that includes the steps of applying a chemically amplified positive resist composition to a substrate to provide a resist film, conducting selective exposure of the resist film, performing post exposure baking (PEB), and then conducting alkali developing, wherein the PEB temperature in the lithography process is set to a temperature within ±2° C. of the PEB temperature at which the line and space pattern formed by this lithography process reaches a maximum.

### TECHNICAL FIELD

The present invention relates to a positive resist composition. More specifically, the present invention relates to a positive resist composition that is suited to the production of electronic elements such as liquid crystal display elements, and relates particularly to a chemically amplified positive resist composition that is ideal for use within processes that use a wavelength of 200 nm or less, and particularly an ArF excimer laser.

### BACKGROUND ART

In recent years, in the production of semiconductor elements and liquid crystal display elements, advances in lithography techniques have lead to rapid progress in the field of miniaturization. Typically, these miniaturization techniques involve shortening the wavelength of the exposure light source. Conventionally, ultraviolet radiation such as g-line and i-line radiation has been used, but nowadays KrF excimer lasers (248 nm) are the main light source used in the mass production of electronic elements, and ArF excimer lasers (193 nm) are now also starting to be introduced as the light source for use in the mass production of electronic elements.

Resists for use with light sources such as KrF excimer lasers and ArF excimer lasers require a high resolution capable of reproducing patterns of minute dimensions, and a high level of sensitivity relative to light sources with this type of short wavelength. One example of a known resist that satisfies these conditions is a chemically amplified positive resist composition, which includes a base resin that exhibits increased alkali solubility under the action of acid, and an acid generator (hereafter referred to as a PAG) that generates acid on exposure.

In the reaction mechanism of a chemically amplified positive resist, exposure causes the PAG within the resist to generate an acid, and this acid causes a change in the solubility of the base resin. For example, if dissolution inhibiting groups that dissociate in the presence of acid are introduced into the base resin of the chemically amplified positive resist, then these dissolution inhibiting groups will dissociate only within the exposed portions of the resist, causing a significant increase in the solubility of the resist in the developing solution within these exposed portions.

Typically, by conducting a heat treatment following exposure (post exposure baking, hereafter abbreviated as PEB), the dissociation of the dissolution inhibiting groups and the diffusion of the acid within the resist is accelerated, enabling a much higher sensitivity to be achieved than that attainable with conventional non-chemically amplified resists.

Moreover recently, the design rules prescribed for semiconductor element production have become even more stringent, and for example, resist materials with resolution capable of forming a resist pattern of 130 nm or less using an ArF excimer laser (193 nm) are now being demanded. In order to meet these demands for miniaturization, the development of resist materials capable of forming very fine resist patterns using an ArF excimer laser is being vigorously pursued.

Until recently, polyhydroxystyrenes or derivatives thereof in which the hydroxyl groups are protected with acid dissociable, dissolution inhibiting groups (hereafter also referred to as hydroxystyrene-based resins), which exhibit high transparency relative to a KrF excimer laser (248 nm), have been used as the base resin component of chemically amplified resists.

However, resins such as hydroxystyrene-based resins that contain benzene rings have insufficient transparency in the vicinity of 193 nm. As a result, chemically amplified resists that use these resins as a base resin suffer from lower levels of resolution.

Accordingly, resist compositions that use the resins (i) and (ii) described below as base resins have been proposed as resist materials which contain no benzene rings, exhibit excellent transparency in the vicinity of 193 nm, and also exhibit superior dry etching resistance.
(i) Resins that contain, within the principal chain, structural units derived from a (meth)acrylate ester containing a polycyclic hydrocarbon group such as an adamantane skeleton at the ester portion (for example, see patent references 1 through 8).
(ii) Polycycloolefin resins that contain a norbornane ring or the like within the principal chain, or copolymer resins of a norbornane ring and maleic anhydride (COMA) (for example, see patent references 9 and 10).

Nowadays, the miniaturization of semiconductor elements has progressed even further, and additional improvements in resist characteristics are being demanded, even for resist compositions using the resins described in (i) and (ii) above.

For example, substrate sizes have increased from 200 mm to 300 mm, but a problem has arisen in that fluctuations are more likely in the size of the resist pattern formed on this type of large substrate surface.

Moreover, in a semiconductor element production line, a plurality of baking treatments such as PEB (post exposure baking) are conducted, and a temperature difference of several degrees can exist between different bake units, and because the size of the formed resist pattern is affected by this temperature, a problem arises in that this resist pattern size can vary depending on the bake unit. Accordingly, the importance of a “PEB margin” is becoming increasingly significant, which means that even when there is a slight variation in the temperature during PEB treatment while forming the resist pattern, the targeted resist pattern size is able to be formed with good stability, independent of the temperature variation.

However, conventional resist materials are unable to adequately resolve these problems, and further improvements are needed.

(Patent Reference 1)

Japanese Patent No. 2,881,969

(Patent Reference 2)

Japanese Unexamined Patent Application, First Publication No. Hei 5-346668

(Patent Reference 3)

Japanese Unexamined Patent Application, First Publication No. Hei 7-234511

(Patent Reference 4)

Japanese Unexamined Patent Application, First Publication No. Hei 9-73173

(Patent Reference 5)

Japanese Unexamined Patent Application, First Publication No. Hei 9-90637

(Patent Reference 6)

Japanese Unexamined Patent Application, First Publication No. Hei 10-161313

(Patent Reference 7)

Japanese Unexamined Patent Application, First Publication No. Hei 10-319595

(Patent Reference 8)

Japanese Unexamined Patent Application, First Publication No. Hei 11-12326

(Patent Reference 9)

Japanese Unexamined Patent Application, First Publication No. Hei 10-10739

(Patent Reference 10)

Japanese Unexamined Patent Application, First Publication No. 2000-235263

(Patent Reference 11)

Japanese Unexamined Patent Application, First Publication No. 2001-356483

(Patent Reference 12)

Japanese Unexamined Patent Application, First Publication No. 2000-310859

### DISCLOSURE OF INVENTION

Accordingly, an object of the present invention is to provide a chemically amplified positive resist composition with high levels of sensitivity and resolution, which yields a uniform resist pattern size within the substrate plane and exhibits a broad PEB margin, as well as a method for forming a resist pattern that uses this chemically amplified positive resist composition.

As a result of intensive investigation, the inventors of the present invention discovered that the above object could be achieved by using a positive resist composition in which the base resin component that contains acid dissociable, dissolution inhibiting groups and exhibits increased alkali solubility under the cation of acid used a copolymer with specific structural units and a Tg value within a specific range.

Furthermore, the inventors of the present invention also discovered that the above object could be achieved by using a method for forming a resist pattern in which patterning is conducted at a PEB temperature within a specific range that is determined by the relationship between the space pattern size of a line and space pattern formed using a typical lithography process and the preliminary PEB temperature used during that process.

The present invention is based on the discoveries described above, and a first aspect of the present invention is a positive resist composition that includes a base resin component (A), which contains acid dissociable, dissolution inhibiting groups and exhibits increased alkali solubility under the action of acid, and an acid generator component (B) that generates acid on irradiation, wherein the component (A) is a copolymer that includes structural units (a-1), which are derived from an (α-lower alkyl) acrylate ester that contains an acid dissociable, dissolution inhibiting group, and also contains an aliphatic cyclic group, structural units (a-2), which are derived from an (α-lower alkyl) acrylate ester that contain a γ-butyrolactone residue, and structural units (a-3), which are derived from an (α-lower alkyl) acrylate ester that contains a hydroxyl group-containing aliphatic polycyclic hydrocarbon group, and the glass transition temperature (Tg) of the copolymer is within a range from 100 to 170° C.

Furthermore, a second aspect of the present invention is a method for forming a resist pattern using a lithography process that includes the steps of applying a chemically amplified positive resist composition to a substrate to provide a resist film, conducting selective exposure of the resist film, performing post exposure baking (PEB), and then conducting alkali developing, wherein

line and space patterns are formed at a plurality of preliminary PEB temperatures using the lithography process, the relationship between the size of the space pattern formed and the preliminary PEB temperature at which that size is formed is plotted in a graph with the size of the formed space pattern along the vertical axis and the preliminary PEB temperature along the horizontal axis, the preliminary PEB temperature corresponding with the point at which the size reaches its maximum value in the graph is set as the optimum PEB temperature, and the PEB temperature within the lithography process is set to a temperature within ±2° C. of this optimum PEB temperature.

In this description, the term “(α-lower alkyl) acrylate” is a generic term that includes α-lower alkyl acrylates such as methacrylate, and acrylate. The term “α-lower alkyl acrylate” refers to a structure in which the hydrogen atom bonded to the α-carbon atom of an acrylate has been substituted with a lower alkyl group.

Furthermore, the term “structural unit” refers to a monomer unit that contributes to the formation of a polymer.

Furthermore, the term “structural unit derived from an (α-lower alkyl) acrylate ester” refers to a structural unit that is formed by the cleavage of the ethylenic double bond of the (α-lower alkyl) acrylate ester.

Furthermore, the term “γ-butyrolactone residue” refers to a group in which one hydrogen atom has been removed from the lactone ring of a γ-butyrolactone that may or may not contain substituent groups.

A positive resist composition of the present invention exhibits high levels of sensitivity and resolution, yields a uniform resist pattern size within the substrate plane, and also exhibits a broad PEB margin. Furthermore, a method for forming a resist pattern of the present invention enables the same effects to be obtained.

### BRIEF DESCRIPTION OF THE DRAWINGS

FIG. 1 is a graph for determining the optimum PEB temperature in the examples 6 and 7.

### BEST MODE FOR CARRYING OUT THE INVENTION

As follows is a more detailed description of the present invention.

A positive resist composition of the present invention includes a base resin component (A) (hereafter referred to as the component (A)), which contains acid dissociable, dissolution inhibiting groups and exhibits increased alkali solubility under the action of acid, and an acid generator component (B) (hereafter referred to as the component (B)) that generates acid on irradiation (hereafter also referred to as exposure).

In the positive resist, when the acid generated from the component (B) by exposure acts upon the component (A), the acid dissociable, dissolution inhibiting groups within the component (A) dissociate, causing the entire positive resist to change from an alkali-insoluble state to an alkali-soluble state. As a result, when the positive resist is exposed through a mask pattern during the formation of a resist pattern, or alternatively, is exposed and then subjected to PEB, the exposed portions of the resist shift to an alkali-soluble state, whereas the unexposed portions remain insoluble in alkali, meaning that alkali developing can then be used to form a positive resist pattern.

<Component (A)>

In the present invention, the component (A) is a copolymer that includes structural units (a-1), which are derived from an (α-lower alkyl) acrylate ester that contains an acid dissociable, dissolution inhibiting group, and also contains an aliphatic cyclic group, structural units (a-2), which are derived from an (α-lower alkyl) acrylate ester that contain a γ-butyrolactone residue, and structural units (a-3), which are derived from an (α-lower alkyl) acrylate ester that contains a hydroxyl group-containing aliphatic polycyclic hydrocarbon group, wherein the glass transition temperature (Tg) of the copolymer is within a range from 100 to 170° C.

In the present invention, by ensuring that the component (A) is a copolymer that includes these structural units (a-1), (a-2), and (a-3), and ensuring that the glass transition temperature (Tg) of the copolymer falls within the specified range, the object of the present invention can be achieved.

In the case of a typical conventional ArF resist, a structural unit derived from an (α-lower alkyl) acrylate ester containing a 2-lower alkyl-2-adamantyl group such as a 2-methyl-2-adamntyl group or 2-ethyl-2-adamantyl group is used as the structural unit that contains an acid dissociable, dissolution inhibiting group, but in these structures, the variation in the Tg value following the removal of the acid dissociable, dissolution inhibiting group is large, which accelerates the diffusion of acid through the exposed resist film, meaning the heat dependency is large and the PEB margin is small.

In the present invention, by selection of each of the structural units (monomer units) of the copolymer resin, and optimization of the Tg value, the variation in Tg upon exposure was suppressed, and as a result, the PEB margin was successfully increased without any loss in sensitivity or resolution. Furthermore, as a result, the in-plane uniformity of the formed resist pattern was also successfully improved.

In the present invention, by ensuring that the Tg value of the copolymer containing the above structural units (a-1), (a-2), and (a-3) is at least 100° C., excellent resolution can be achieved, whereas by ensuring that the Tg value is no higher than 170° C., a superior PEB margin is obtained.

The Tg value is even more preferably within a range from 115 to 170° C., and most preferably from 130 to 165° C.

Furthermore, in order to achieve this type of Tg value, the weight average molecular weight (Mw; the polystyrene equivalent value determined using gel permeation chromatography) of the copolymer is typically within a range from 2,000 to 8,000, and values within a range from 5,000 to 8,000, and even more preferably from 5,000 to 7,000, are preferred as they yield resins with even more appropriate Tg values.

Furthermore, In order to achieve this type of Tg value, the polydispersity of the copolymer is preferably no more than 2.5, even more preferably 1.7 or less, and most preferably 1.6 or less.

There are no particular restrictions on the acid dissociable, dissolution inhibiting group within the component (A), provided it exhibits an alkali dissolution inhibiting effect that renders the entire component (A) alkali-insoluble prior to exposure, but then dissociates under the action of acid generated from the component (B) following exposure, causing the entire component (A) to shift to an alkali-soluble state, and known groups can be used.

As this acid dissociable, dissolution inhibiting group, either one, or a combination of two or more groups typically used in (meth)acrylate-based resins can be used, and specific examples include chain-like alkoxyalkyl groups, tertiary alkyloxycarbonyl groups, tertiary alkyl groups, tertiary alkoxycarbonylalkyl groups, and cyclic ether groups.

Examples of suitable chain-like alkoxyalkyl groups include a 1-ethoxyethyl group, 1-methoxymethylethyl group, 1-isopropoxyethyl group, 1-methoxypropyl group, and 1-n-butoxyethyl group.

Examples of suitable tertiary alkyloxycarbonyl groups include a tert-butyloxycarbonyl group and a tert-amyloxycarbonyl group.

Examples of suitable tertiary alkyl groups include branched-chain tertiary alkyl groups such as a tert-butyl group and a tert-amyl group; tertiary alkyl groups that contain an aliphatic polycyclic group, such as a 2-methyl-2-adamntyl group and a 2-ethyl-2-adamantyl group; and tertiary alkyl groups that contain an aliphatic monocyclic group, such as a 1-methyl-1-cyclohexyl group and a 1-ethyl-1-cyclohexyl group.

Examples of suitable tertiary alkoxycarbonylalkyl groups include a tert-butyloxycarbonylmethyl group and a tert-amyloxycarbonylmethyl group.

Examples of suitable cyclic ether groups include a tetrahydropyranyl group and a tetrahydrofuranyl group.

These types of acid dissociable, dissolution inhibiting groups are typically bonded to resin side chains, and more specifically, are preferably bonded to the ester portion of a structural unit derived from a carboxylate ester. Of these possibilities, bonding to the ester portion of a structural unit derived from an (α-lower alkyl) acrylate ester is particularly desirable.

In the present invention, of the acid dissociable, dissolution inhibiting groups described above, tertiary alkyl groups are preferred, and aliphatic cyclic group-containing tertiary alkyl groups such as aliphatic polycyclic group-containing tertiary alkyl groups and aliphatic monocyclic group-containing tertiary alkyl groups (which are included within the structural units (a-1) described below) are even more preferred, and aliphatic polycyclic group-containing tertiary alkyl groups are particularly desirable.

In addition, as this aliphatic polycyclic group-containing tertiary alkyl group, an aliphatic polycyclic group-containing tertiary alkyl group in which the carbon atom bonded to the ester portion of the (α-lower alkyl) acrylate ester forms the tertiary alkyl group is preferred.

Examples of the aliphatic monocyclic group in an aforementioned aliphatic monocyclic group-containing tertiary alkyl group include groups in which one hydrogen atom has been removed from a cycloalkane such as cyclopentane or cyclohexane.

As the aliphatic polycyclic group in an aforementioned aliphatic polycyclic group-containing tertiary alkyl group, any of the multitude of groups proposed for use within ArF resists can be used. Specific examples of suitable groups include groups in which one hydrogen atom has been removed from a bicycloalkane, tricycloalkane or tetracycloalkane or the like, including polycycloalkanes such as adamantane, norbornane, isobornane, tricyclodecane or tetracyclododecane. Of these groups, adamantyl groups, norbornyl groups, and tetracyclodecanyl groups are preferred industrially.

Structural Unit (a-1)

The structural unit (a-1) is a structural unit derived from an (α-lower alkyl) acrylate ester that contains an acid dissociable, dissolution inhibiting group, and also contains an aliphatic cyclic group.

Examples of this type of structural unit (a-1) include: structural units (a-1-1), which contain, as the acid dissociable, dissolution inhibiting group, an aliphatic cyclic group-containing acid dissociable, dissolution inhibiting group that includes an aliphatic cyclic group-containing tertiary alkyl group such as an aliphatic polycyclic group-containing tertiary alkyl group or an aliphatic monocyclic group-containing tertiary alkyl group within the acid dissociable, dissolution inhibiting group described above; and structural units (a-1-2) in which an aforementioned polycyclic group is bonded to the ester portion of the (α-lower alkyl) acrylate ester, and an acid dissociable, dissolution inhibiting group is then bonded to this polycyclic group.

In other words, in the structural unit (a-1), the acid dissociable, dissolution inhibiting group may include the aliphatic cyclic group, as in the case of the structural unit (a-1-1), or the acid dissociable, dissolution inhibiting group and the aliphatic polycyclic group may be different, as in the case of the structural unit (a-1-2).

Of these options, aliphatic cyclic group-containing tertiary alkyl groups produce particularly superior effects for the present invention and are consequently preferred, and aliphatic polycyclic group-containing tertiary alkyl groups are particularly desirable.

As the structural unit (a-1), one or more structural units selected from a group consisting of structural units represented by the general formulas (I), (II), and (III) shown below, which contain a tertiary alkyl group as the acid dissociable, dissolution inhibiting group, and also contain an aliphatic polycyclic group, produce excellent dry etching resistance and a higher level of resolution, and are consequently preferred.

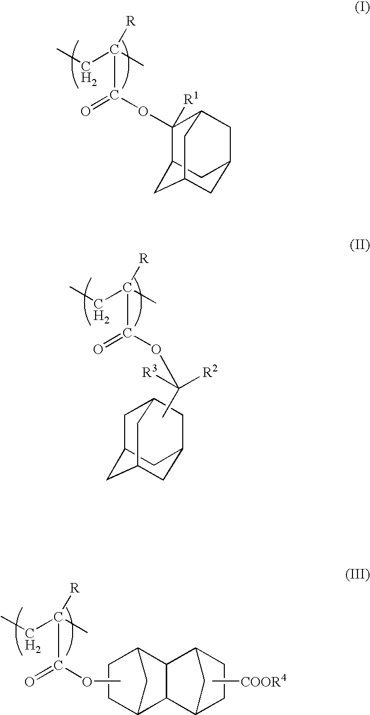

In the above general formulas (I) through (III), R represents a hydrogen atom or a lower alkyl group, R¹ represents a lower alkyl group, R² and R³ each represent, independently, a lower alkyl group, and R⁴ represents a tertiary alkyl group.

The lower alkyl group represented by R may be either a straight-chain or branched group, and is preferably an alkyl group of 1 to 5 carbon atoms, and even more preferably a methyl group.

The lower alkyl groups represented by R¹, R², and R³ may be either straight-chain or branched groups, and each is preferably an alkyl group of 1 to 5 carbon atoms, and even more preferably a methyl group or ethyl group with 1 to 2 carbon atoms.

Examples of the tertiary alkyl group represented by R⁴ include branched-chain tertiary alkyl groups of 4 or 5 carbon atoms such as a tert-butyl group or tert-amyl group.

Of these, the inclusion of a structural unit represented by the general formula (I), and in particular a structural unit derived from an (α-lower alkyl) acrylate ester that contains a 2-lower alkyl-2-adamantyl group such as a 2-methyl-2-adamantyl group or 2-ethyl-2-adamantyl group is preferred, as such structural units yield a Tg value that falls within the ideal range, and enable the formation of a resist pattern with an excellent PEB margin. In addition to the structural units listed above, 1-ethyl-1-cyclohexyl (α-lower alkyl) acrylates, 1-methyl-1-cyclohexyl (α-lower alkyl) acrylates, 1-ethyl-1-cyclopentyl (α-lower alkyl) acrylates, and 1-methyl-1-cyclopentyl (α-lower alkyl) acrylates and the like can also be used favorably.

Structural Unit (a-2)

In addition to the structural unit (a-1) described above, the component (A) also includes a structural unit (a-2) derived from an (α-lower alkyl) acrylate ester that contains a γ-butyrolactone residue. Inclusion of this structural unit can improve the adhesion between the resist film and the substrate, and enhance the affinity between the component and the developing solution, which reduces the likelihood of film peeling and the like, even within very fine resist patterns.

Preferred examples of the structural unit (a-2) include the structural units represented by a general formula (IV) shown below. 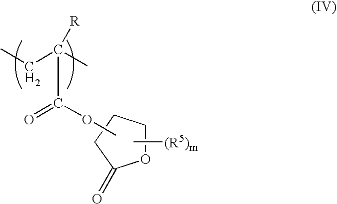
(wherein, R is as defined above, each R⁵ represents, independently, a hydrogen atom or a lower alkyl group, and m represents an integer from 1 to 4. The lower alkyl group represented by R⁵ may be either a straight-chain or branched group, and is preferably an alkyl group of 1 to 5 carbon atoms, and even more preferably 1 to 3 carbon atoms. R⁵ is most preferably a hydrogen atom.)

Of these, structural units represented by the general formula (IV) in which R⁵ is a hydrogen atom, and the α-position of the lactone is bonded to the ester linkage of the (α-lower alkyl) acrylate ester, that is, structural units represented by a general formula (V) shown below, offer excellent substrate adhesion, resolution, and PEB margin, and are consequently the most desirable. 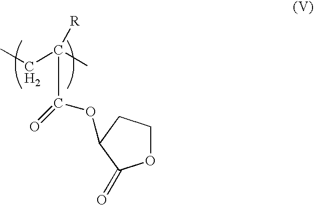
(wherein, R is as defined above)
Structural Unit (a-3)

Furthermore, in addition to the aforementioned structural units (a-1) and (a-2), the component (A) also includes a structural unit (a-3) derived from an (α-lower alkyl) acrylate ester that contains a hydroxyl group-containing aliphatic polycyclic hydrocarbon group. Inclusion of the structural unit (a3) enhances the affinity between the entire component (A) and the developing solution, which improves the alkali solubility of the exposed portions. This contributes to an improvement in the resolution.

As the aliphatic polycyclic group within the structural unit (a-3), any group selected from the same plurality of polycyclic groups listed above for the structural unit (a-1) can be used.

Preferred examples of the structural unit (a-3) include the structural units represented by a general formula (VI) shown below. 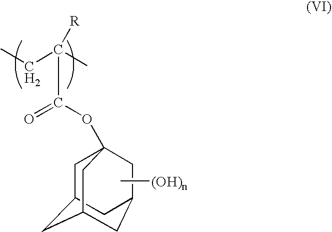
(wherein, R is as defined above, and n is an integer from 1 to 3)

Of these structural units, the unit in which n represents 1, and the hydroxyl group is bonded to position 3 of the adamantyl group is preferred.

In terms of the relative proportions of each of these structural units, the proportion of the structural unit (a-1) is typically within a range from 20 to 60 mol %, and preferably from 30 to 50 mol %, as such proportions yield superior resolution.

The proportion of the structural unit (a-2) is typically within a range from 20 to 60 mol %, and preferably from 20 to 50 mol %, as such proportions yield superior resolution.

The proportion of the structural unit (a-3) is typically within a range from 1 to 50 mol %, and preferably from 10 to 40 mol %, as such proportions yield superior resist pattern shape.

Of the various possible resins for the component (A) of the present invention, resins which include a combination wherein (a-1) is a structural unit represented by the general formula (I), and preferably includes a 2-methyladamantyl group, (a-2) is a structural unit represented by the general formula (V), and (a-3) is a structural unit represented by the general formula (VI), in which n is 1 and the hydroxyl group is bonded to position 3 of the adamantyl group are preferred.

Furthermore, specific examples of the structural units derived from an (α-lower alkyl) acrylate ester include the three types of units (i) through (iii) described below.
(i) Full acrylate polymers containing solely structural units derived from acrylate esters (hereafter also abbreviated as structural units (aa)).
(ii) Full methacrylate polymers containing solely structural units derived from methacrylate esters (hereafter also abbreviated as structural units (ma)).
(iii) acrylate-methacrylate copolymers containing both structural units (aa) and structural units (ma).

The Tg value of the resin of the component (A) of the present invention also varies depending on the ratio between these structural units (aa) and structural units (ma).

Taking into consideration each of the structural units of a copolymer resin, as well as (aa) and (ma), the copolymers (A1) and (A2) described below exhibit favorable sensitivity, resolution and PEB margin, and also enable a uniform resist pattern size to be obtained within the substrate plane, and are consequently preferred.

[Copolymer (A1)]

A copolymer which includes a combination of a structural unit (a-1-m) represented by the general formula (I) wherein R is a methyl group as the structural unit (a-1),

a structural unit (a-2-m) represented by the general formula (V) wherein R is a methyl group as the structural unit (a-2), and

a structural unit (a-3-m) represented by the general formula (VI), wherein n is 1, the hydroxyl group is bonded to position 3 of the adamantyl group, and R is a methyl group as the structural unit (a-3), wherein

the Tg value is within a range from 150 to 165° C.

[Copolymer (A2)]

A copolymer which includes a combination of a structural unit (a-1-a) represented by the general formula (I) wherein R is a hydrogen atom as the structural unit (a-1),

the aforementioned structural unit (a-2-m), and

the aforementioned structural unit (a-3-m), wherein the Tg value is within a range from 115 to 140° C.

Structural Unit (a-4)

Furthermore, the component (A) may also include, as a structural unit (a-4), a structural unit derived from an (α-lower alkyl) acrylate ester containing an aliphatic polycyclic group which is different from the aforementioned structural units (a-1), (a-2), and (a-3), or any other conventional unit, provided the resulting Tg value falls within the specified range and the effects of the present invention are not impaired.

Here the expression “different from the structural units (a-1), (a-2), and (a-3)” means the structural unit must not duplicate any of these other structural units.

Examples of the aliphatic polycyclic group include the same plurality of aliphatic polycyclic groups described in relation to the aforementioned structural units (a-1), (a-2), and (a-3).

As this type of structural unit (a-4), a multitude of units are already known as ArF positive resist materials, but in particular, units derived from one or more of tricyclodecanyl(meth)acrylate, adamantyl(meth)acrylate, tetracyclodecanyl(meth)acrylate, and isobornyl(meth)acrylate are preferred in terms of their industrial availability. Furthermore, these structural units are non-acid-dissociable groups.

These structural units are shown below as structural formulas. 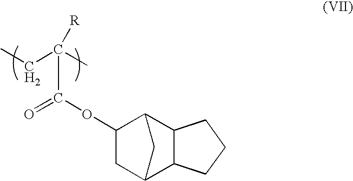
(wherein, R is as defined above) 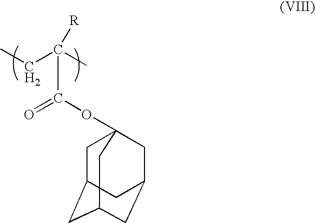
(wherein, R is as defined above) 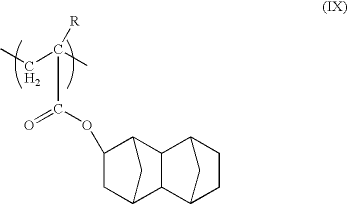
(wherein, R is as defined above)

In the case of a quaternary system, setting the relative proportions of each of the units within a range from 25 to 50 mol %, and preferably from 30 to 40 mol % for the structural unit (a-1), within a range from 25 to 50 mol %, and preferably from 30 to 40 mol % for the structural unit (a-2), within a range from 10 to 30 mol %, and preferably from 10 to 20 mol % for the structural unit (a-3), and within a range from 5 to 25 mol %, and preferably from 10 to 20 mol % for the structural unit (a-4) improves the depth of focus for isolated patterns and enables a reduction in the proximity effect, and is consequently preferred. If the proportions fall outside these ranges, then a problem arises in that the resolution tends to decrease.

Method of Synthesizing the Component (A)

In the present invention, the component (A) can be synthesized using a conventional radical polymerization method.

Conventionally, the most commonly known method of synthesis is a free radical polymerization.

Furthermore, methods referred to as living anionic polymerization and living radical polymerization are also known.

<Component (B)>

As the component (B), any of the compounds known as conventional acid generators for use within chemically amplified resists can be appropriately selected and used.

Of these acid generators, onium salts containing a fluorinated alkylsulfonate ion as the anion are preferred. Examples of preferred acid generators include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, triphenylsulfonium nonafluorobutanesulfonate, (4-trifluoromethylphenyl)diphenylsulfonium trifluoromethanesulfonate, (4-trifluoromethylphenyl)diphenylsulfonium nonafluorobutanesulfonate, and tri(p-tert-butylphenyl)sulfonium trifluoromethanesulfonate. Of these, sulfonium salts are preferred, and nonafluorobutanesulfonate salts are particularly desirable.

As the component (B), either a single acid generator may be used alone, or a combination of two or more different acid generators may be used.

The quantity used of the component (B) is typically within a range from 0.5 to 30 parts by weight, and preferably from 1 to 10 parts by weight, per 100 parts by weight of the component (A). If the quantity is less than 0.5 parts by weight, then pattern formation may not progress satisfactorily, whereas if the quantity exceeds 30 parts by weight, it becomes difficult to achieve a uniform solution, and there is also a danger of a deterioration in the storage stability.

<Organic Solvent (C)>

A positive resist composition of the present invention can be produced by dissolving the materials in an organic solvent (C).

The component (C) may be any solvent capable of dissolving each of the components used to generate a uniform solution, and either one, or two or more solvents selected from known materials used as the solvents for conventional chemically amplified resists can be used.

Suitable examples include lactones such as γ-butyrolactone; ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methyl pyruvate, ethyl pyruvate, methyl methoxypropionate, and ethyl ethoxypropionate. These organic solvents may be used either alone, or as a mixed solvent of two or more different solvents. In those cases where a mixed solvent of propylene glycol monomethyl ether acetate (PGMEA) and a polar solvent is used, the mixing ratio can be determined on the basis of the co-solubility of the PGMEA and the polar solvent, but is preferably within a range from 1:9 to 9:1, and even more preferably from 2:8 to 8:2.

More specifically, in those cases where ethyl lactate (EL) is added as the polar solvent, the weight ratio of PGMEA:EL is preferably within a range from 2:8 to 8:2, and even more preferably from 3:7 to 7:3. Furthermore, as the organic solvent, a mixed solvent of at least one of PGMEA and EL, together with γ-butyrolactone is also preferred. In such cases, the mixing ratio is set so that the weight ratio between the former and latter components is preferably within a range from 70:30 to 95:5.

There are no particular restrictions on the quantity used of the component (C), which is set in accordance with the applied film thickness so as to produce a concentration that enables favorable application to a substrate or the like, and is typically sufficient to produce a solid fraction concentration within the resist composition of 2 to 20% by weight, and preferably from 5 to 15% by weight.

<Nitrogen-containing Organic Compound (D)>

In order to improve the resist pattern shape and the post exposure stability of the latent image formed by the pattern-wise exposure of the resist layer, a nitrogen-containing organic compound can also be added to a positive resist composition of the present invention as an optional component (D).

A multitude of these nitrogen-containing organic compounds have already been proposed, and one of these known compounds can be used, although a secondary lower aliphatic amine or tertiary lower aliphatic amine is preferred.

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine, triethanolamine and triisopropanolamine, and of these, tertiary alkanolamines such as triethanolamine and triisopropanolamine are particularly preferred.

These may be used either alone, or in combinations of two or more different compounds.

These compounds (of the component (D)) are typically added in a quantity within a range from 0.01 to 5.0 parts by weight per 100 parts by weight of the component (A).

Furthermore, in order to prevent any deterioration in sensitivity caused by the addition of the aforementioned component (D), and improve the resist pattern shape and the post exposure stability of the latent image formed by the pattern-wise exposure of the resist layer, an organic carboxylic acid, or a phosphorus oxo acid or derivative thereof can also be added as an optional component (E). The component (D) and the component (E) can be used in combination, or either one can also be used alone.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or derivatives thereof such as esters, including phosphoric acid, di-n-butyl phosphate, and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred.

The component (E) is typically used in a quantity within a range from 0.01 to 5.0 parts by weight per 100 parts by weight of the component (A).

<Other Optional Components>

Other miscible additives can also be added to a positive resist composition of the present invention according to need, and examples include additive resins for improving the properties of the resist film, surfactants for improving the ease of application, dissolution inhibitors, plasticizers, stabilizers, colorants, halation prevention agents, and dyes.

The positive resist composition of the present invention described above exhibits high levels of sensitivity and resolution, yields a uniform resist pattern size within the substrate plane, and also exhibits a broad PEB margin.

<<Method for Forming Resist Pattern>>

A method for forming a resist pattern that represents the second aspect of the present invention is a method for forming a resist pattern using a lithography process that includes the steps of applying a chemically amplified positive resist composition to a substrate to provide a resist film, conducting selective exposure of the resist film, performing post exposure baking (PEB), and then conducting alkali developing, wherein an optimum PEB temperature that has been determined in advance is employed.

In other words, in a method for forming a resist pattern according to the present invention, first, line and space patterns are formed at a plurality of preliminary PEB temperatures using the lithography process, the relationship between the size of the space pattern formed and the preliminary PEB temperature at which that size is formed is plotted on a graph with the size of the formed space pattern along the vertical axis and the preliminary PEB temperature along the horizontal axis, the preliminary PEB temperature corresponding with the point at which the size reaches its maximum value in the plotted graph is set as the optimum PEB temperature, and the PEB temperature within the lithography process is then set to a temperature within ±2° C. of this optimum PEB temperature.

The lithography process for which the optimum PEB temperature is determined is a typical process, and more specifically, can be conducted in the manner described below.

Namely, a chemically amplified positive resist composition is first applied to the surface of a substrate such as a silicon wafer using a spinner or the like, and a prebake is then conducted under temperature conditions of 80 to 150° C. for 40 to 120 seconds, and preferably for 60 to 90 seconds. The thus obtained film is then subjected to selective exposure with ArF excimer laser light through a desired mask pattern using, for example, an ArF exposure apparatus, and PEB (post exposure baking) is then conducted under temperature conditions of 80 to 150° C. for 40 to 120 seconds, and preferably for 60 to 90 seconds. Subsequently, a developing treatment is conducted using an alkali developing solution such as a 0.1 to 10% by weight aqueous solution of tetramethylammonium hydroxide. In this manner, a resist pattern which is faithful to the mask pattern can be obtained.

An organic or inorganic anti-reflective film may also be provided between the substrate and the applied layer of the resist composition.

Furthermore, there are no particular restrictions on the wavelength used for the exposure, and exposure can be conducted using an ArF excimer laser, KrF excimer laser, F₂ excimer laser, or other radiation such as EUV (extreme ultraviolet), VUV (vacuum ultraviolet), EB (electron beam), X-ray or soft X-ray radiation. A resist composition according to the present invention is particularly effective for exposure using an ArF excimer laser. Furthermore, the term “selective exposure” also includes direct patterning using an electron beam.

Using a method for forming a resist pattern that employs a typical lithography process such as that described above, the heating temperature at which PEB is conducted (the preliminary PEB temperature) is varied, and a line and space pattern is formed under each of the preliminary PEB temperature conditions. If a graph is then plotted with the space pattern size of the formed line and space pattern along the vertical axis and the preliminary PEB temperature at which that space pattern size is formed along the horizontal axis, then a peak-shaped graph is formed. During this process, the conditions other than the preliminary PEB temperature are preferably kept constant.

In other words, at a certain preliminary PEB temperature (the optimum PEB temperature), the space pattern size reaches a maximum, and the space pattern size then decreases with deviation from this optimum PEB temperature. The reason for this observation is unclear, but it is thought that at PEB temperatures lower than the optimum PEB temperature, the diffusion through the resist of the acid generated from the component (B) deteriorates as the PEB temperature falls, causing the space pattern size to decrease, whereas at PEB temperatures higher than the optimum PEB temperature, as the PEB temperature increases, the heat-softened resist migrates more readily into the space portions, causing the space pattern size to decrease.

Once the optimum PEB temperature has been determined in the manner described above, by subsequently conducting patterning using the typical lithography process described above, at a PEB temperature within ±2° C. of this optimum PEB temperature, a resist pattern can be formed at high levels of sensitivity and resolution, with a uniform resist pattern size within the substrate plane, and with a broad PEB margin. The lithography conditions during this process are preferably the same as those used during determination of the optimum PEB temperature.

More specifically, the optimum PEB temperature can be determined in the manner described below.

First, the PEB temperature (the preliminary PEB temperature) is varied while the remaining lithography conditions are kept constant, and line and space patterns are formed using a typical lithography process. The specifications of this line and space pattern are arbitrary, but typically, setting the numerical aperture NA of the exposure apparatus lens to a value within a range from 0.6 to 0.9 results in a line and space pattern of approximately 80 nm to 130 nm.

In the examples of the method of the present invention, the lithography process is conducted using a 120 nm line and space pattern.

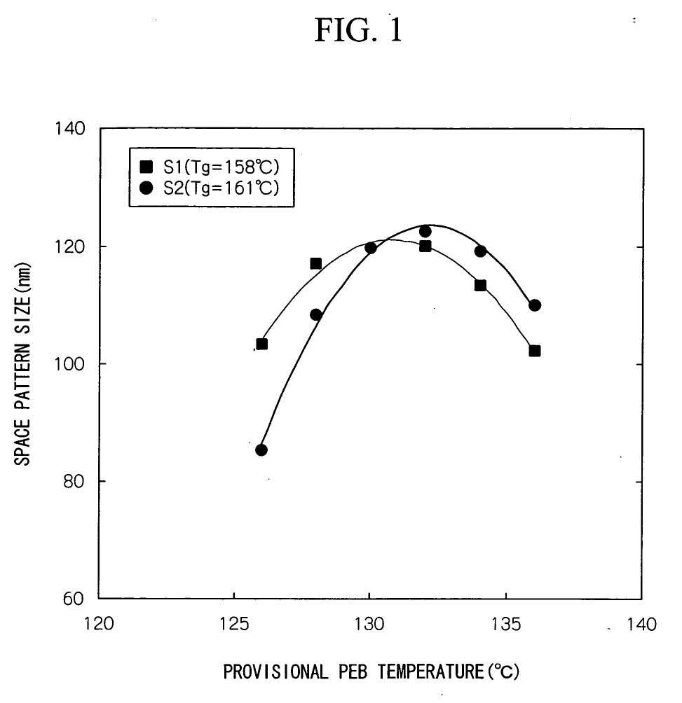

Subsequently, a graph is then plotted with the space pattern size at each of the PEB temperature conditions along the vertical axis, and the preliminary PEB temperature at which that space pattern size is formed along the horizontal axis (see FIG. 1).

The preliminary PEB temperature that corresponds with the peak of the thus formed graph, that is, the point at which the space pattern size reaches its maximum value, is then deemed the optimum PEB temperature.

Subsequently, a temperature within ±2° C., and preferably within ±1° C., of this optimum PEB temperature is used as the PEB temperature within the lithography process for producing the actual resist pattern. By ensuring that the PEB temperature falls within this range, the object described above is achieved. The other lithography conditions are preferably kept the same as the conditions used during determination of the optimum PEB temperature. In the second aspect of the present invention, methods in which the PEB temperature is within ±2° C. of the above optimum PEB temperature, while at the same time, the PEB margin is no more than 4.0 nm/° C., and preferably no more than 3.5 nm/° C., are particularly preferred.

The term “preliminary PEB temperature” refers to a PEB temperature used for producing the type of graph described above.

As the chemically amplified positive resist composition for use within this type of method, a positive resist composition according to the first aspect is ideal. By using a positive resist composition of the first aspect, the PEB margin can be broadened further, and a resist pattern with high levels of sensitivity, resolution, and in-plane uniformity can be formed.

### EXAMPLES

As follows is a more detailed description of the present invention, using a series of examples.

### Example 1

100 parts by weight of a copolymer represented by structural formulas shown below (weight average molecular weight: 5,300, polydispersity: 2.06, Tg: 147° C.), together with 2.0 parts by weight of p-methylphenyldiphenylsulfonium nonafluorobutanesulfonate and 0.8 parts by weight of tri(tert-butylphenyl)sulfonium trifluoromethanesulfonate as an acid generator component, and 0.25 parts by weight of triethanolamine as a nitrogen-containing organic compound component were dissolved in 25 parts by weight of γ-butyrolactone and 900 parts by weight of a mixture (weight ratio 8:2) of propylene glycol monomethyl ether acetate and ethyl lactate, thus yielding a positive resist composition. 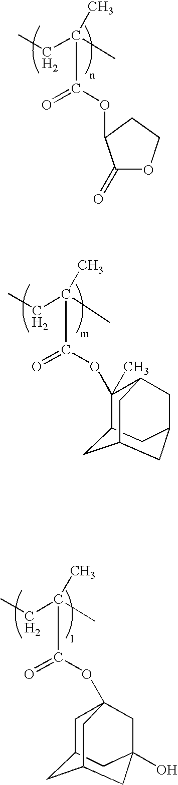
(wherein, n:m:l=40 mol %: 40 mol %: 20 mol %)

Subsequently, an organic anti-reflective film composition ARC-29A (a product name, manufactured by Brewer Science Ltd.) was applied to the surface of a silicon wafer using a spinner, and the composition was then baked and dried on a hotplate at 215° C. for 60 seconds, thereby forming an organic anti-reflective film with a film thickness of 77 nm. The above positive resist composition was then applied to the surface of this organic anti-reflective film using a spinner, and was then prebaked and dried on a hotplate at 125° C. for 90 seconds, thereby forming a resist layer with a film thickness of 250 nm. The thus obtained resist layer was then selectively irradiated with an ArF excimer laser (193 nm) through a mask pattern (binary), using an ArF exposure apparatus NSR-S302 (manufactured by Nikon Corporation; NA (numerical aperture)=0.60, 2/3 annular illumination). A PEB treatment was then conducted at 130° C. for 90 seconds, and the resist layer was subjected to puddle development for 30 seconds at 23° C. in a 2.38% by weight aqueous solution of tetramethylammonium hydroxide, and was then washed for 20 seconds with water and dried, thus forming a resist pattern.

As a result, the resolution for a trench pattern when exposure was conducted using the same exposure dose of 23 mJ/cm² required to transfer a 130 nm mask obtained using the positive resist composition of this example at 130 nm, was 133 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the trench pattern, the PEB temperature was varied between 125° C., 130° C., and 135° C., and the size of the resist pattern formed at each temperature was determined, and when the degree of variation in the resist pattern size per unit of temperature was subsequently determined, the result was a small 1.6 nm/° C., which represents a favorable result.

### Example 2

With the exception of replacing the copolymer of the example 1 with 100 parts by weight of a copolymer of the same structural formulas but with a weight average molecular weight of 7,800, a polydispersity of 1.98, and a Tg value of 160° C., a positive resist composition was prepared with the same composition as that of the example 1.

When patterning was then conducted in the same manner as the example 1, the resolution for a trench pattern when exposure was conducted using the same exposure dose of 23 mJ/cm² required to transfer a 130 nm mask obtained using the positive resist composition of this example at 130 nm, was 131 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the trench pattern, the PEB temperature was varied between 130° C. and 135° C., and the size of the resist pattern formed at each temperature was determined, and when the degree of variation in the resist pattern size per unit of temperature was subsequently determined, the result was a small 4.9 nm/° C., which represents a favorable result.

### Example 3

With the exception of replacing the copolymer of the example 1 with 100 parts by weight of a copolymer of the same structural formulas but with a weight average molecular weight of 6,500, a polydispersity of 1.59, and a Tg value of 161° C., a positive resist composition was prepared with the same composition as that of the example 1.

When patterning was then conducted in the same manner as the example 1, the resolution for a trench pattern when exposure was conducted using the same exposure dose of 22 mJ/cm² required to transfer a 130 nm mask obtained using the positive resist composition of this example at 130 nm, was 137 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the trench pattern, the PEB temperature was varied between 125° C., 130° C., and 135° C., and the size of the resist pattern formed at each temperature was determined, and when the degree of variation in the resist pattern size per unit of temperature was subsequently determined, the result was a small 2.3 nm/° C., which represents a favorable result.

### Example 4

With the exception of replacing the copolymer of the example 1 with 100 parts by weight of a copolymer of the same structural formulas but with a weight average molecular weight of 7,100, a polydispersity of 1.70, and a Tg value of 167° C., a positive resist composition was prepared with the same composition as that of the example 1.

When patterning was then conducted in the same manner as the example 1, the resolution for a trench pattern when exposure was conducted using the same exposure dose of 22 mJ/cm² required to transfer a 130 nm mask obtained using the positive resist composition of this example at 130 nm, was 130 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the trench pattern, the PEB temperature was varied between 125° C., 130° C., and 135° C., and the size of the resist pattern formed at each temperature was determined, and when the degree of variation in the resist pattern size per unit of temperature was subsequently determined, the result was a small 3.1 nm/° C., which represents a favorable result.

### Example 5

With the exception of replacing the copolymer of the example 1 with 100 parts by weight of a copolymer of the same structural formulas but with a weight average molecular weight of 6,500, a polydispersity of 1.58, and a Tg value of 158° C., a positive resist composition was prepared with the same composition as that of the example 1.

When patterning was then conducted in the same manner as the example 1, the resolution for a trench pattern when exposure was conducted using the same exposure dose of 22 mJ/cm² required to transfer a 130 nm mask obtained using the positive resist composition of this example at 130 nm, was 136 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the trench pattern, the PEB temperature was varied between 130° C. and 135° C., and the size of the resist pattern formed at each temperature was determined, and when the degree of variation in the resist pattern size per unit of temperature was subsequently determined, the result was a small 1.5 nm/° C., which represents a favorable result.

### Comparative Example 1

With the exception of replacing the copolymer of the example 1 with 100 parts by weight of a copolymer of the same structural formulas but with a weight average molecular weight of 10,200, a polydispersity of 2.29, and a Tg value of 172° C., a positive resist composition was prepared with the same composition as that of the example 1.

When patterning was then conducted in the same manner as the example 1, the resolution for a trench pattern when exposure was conducted using the same exposure dose of 23 mJ/cm² required to transfer a 130 nm mask obtained using the positive resist composition of this comparative example at 130 nm, was 127 nm, and the pattern shape was favorable, but there was considerable variation in the size of each of the resist patterns formed on the wafer, and the in-plane uniformity was poor.

Furthermore, in order to determine the PEB margin of the trench pattern, the PEB temperature was varied between 130° C. and 135° C., and the size of the resist pattern formed at each temperature was determined, and when the degree of variation in the resist pattern size per unit of temperature was subsequently determined, the result was 5.0 nm/° C., which is unsatisfactory.

### Comparative Example 2

With the exception of replacing the copolymer of the example 1 with 100 parts by weight of a copolymer of the same structural formulas but with a weight average molecular weight of 11,100, a polydispersity of 2.42, and a Tg value of 179° C., a positive resist composition was prepared with the same composition as that of the example 1.

When patterning was then conducted in the same manner as the example 1, the resolution for a trench pattern when exposure was conducted using the same exposure dose of 23 mJ/cm² required to transfer a 130 nm mask obtained using the positive resist composition of this comparative example at 130 nm, was 126 nm, and the pattern shape was favorable, but there was considerable variation in the size of each of the resist patterns formed on the wafer, and the in-plane uniformity was poor.

Furthermore, in order to determine the PEB margin of the trench pattern, the PEB temperature was varied between 130° C. and 135° C., and the size of the resist pattern formed at each temperature was determined, and when the degree of variation in the resist pattern size per unit of temperature was subsequently determined, the result was 7.1 nm/° C., which is unsatisfactory.

### Comparative Example 3

With the exception of replacing the copolymer of the example 1 with 100 parts by weight of a copolymer of the same structural formulas but with a weight average molecular weight of 8,800, a polydispersity of 1.79, and a Tg value of 175° C., a positive resist composition was prepared with the same composition as that of the example 1.

When patterning was then conducted in the same manner as the example 1, the resolution for a trench pattern when exposure was conducted using the same exposure dose of 22 mJ/cm² required to transfer a 130 nm mask obtained using the positive resist composition of this comparative example at 130 nm, was 130 nm, and the pattern shape was favorable, but there was considerable variation in the size of each of the resist patterns formed on the wafer, and the in-plane uniformity was poor.

Furthermore, in order to determine the PEB margin of the trench pattern, the PEB temperature was varied between 130° C. and 135° C., and the size of the resist pattern formed at each temperature was determined, and when the degree of variation in the resist pattern size per unit of temperature was subsequently determined, the result was 5.2 nm/° C., which is unsatisfactory.

### Examples 6 and 7, Comparative Examples 4 and 5

Using the positive resist compositions used in the example 3 and the example 5, but with the exceptions of altering the pattern formed from the trench pattern described in the examples 3 and 5 to a 120 nm line and space pattern, varying the PEB temperature (preliminary PEB temperature) within a range from 125 to 140° C., and conducting exposure at the exposure dose required to transfer a 120 nm mask obtained using the positive resist composition of these examples at 120 nm, resist patterns were formed in the same manner as the examples 3 and 5.

Subsequently, by placing the preliminary PEB temperature along the horizontal axis, and the space size of the line and space pattern formed at each preliminary PEB temperature along the vertical axis, two separate peak-shaped graphs were obtained (see FIG. 1). In FIG. 1, the graph S1 corresponds with the example using the positive resist composition of the example 5 (namely, the example 7), and the graph S2 corresponds with the example using the positive resist composition of the example 3 (namely, the example 6).

From these graphs it is evident that the PEB temperatures corresponding with the S1 and S2 graph peaks (the optimum PEB temperatures) are approximately 131° C. and approximately 132° C. respectively.

Subsequently, using the positive resist composition of the example 5, a line and space pattern was formed in the same manner as described above, using a PEB temperature of 130° C.

The aforementioned exposure dose determined for the example 5 was 22 mJ/cm², the space size of the line and space pattern formed at that exposure dose was 120 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the line and space pattern, the PEB temperature was varied between 128° C., 130° C., 132° C., and 134° C., and when the degree of variation in the resist pattern size per unit of temperature at 129° C. and 133° C., which represent the limits of the temperature range 131±2° C., was determined by dividing the space sizes corresponding with those temperatures ±1° C. by 2° C., the results were 1.4 nm/° C. and 3.3 nm/° C., which represent favorable results. When the PEB margins at 128° C. and 134° C. were determined in the same manner, the results were 6.9 nm/° C. and 5.6 nm/° C., which are unsatisfactorily large (comparative example 4).

Furthermore, using the positive resist composition of the example 3, a line and space pattern was formed in the same manner as described above, using a PEB temperature of 130° C.

The aforementioned exposure dose for transfer determined for the example 3 was 22 mJ/cm², the space size of the line and space pattern formed at that exposure dose was 127 nm, and the pattern shape was favorable.

Furthermore, when the difference between the maximum size and minimum size of each of the resist patterns formed on the wafer was determined, the result of 2 to 3 nm was extremely small, indicating a satisfactorily high level of in-plane uniformity.

Furthermore, in order to determine the PEB margin of the line and space pattern, the PEB temperature was varied between 128° C., 130° C., 132° C., and 134° C., and when the degree of variation in the resist pattern size per unit of temperature at 130° C. and 134° C., which represent the limits of the temperature range 132±2° C., was determined by dividing the space sizes corresponding with those temperatures ±1° C. by 2° C., the results were 3.5 nm/° C. and 3.1 nm/° C., which represent favorable results. When the PEB margins at 129° C. and 135° C. were determined in the same manner, the results were 5.7 nm/° C. and 4.6 min/° C., which are unsatisfactorily large (comparative example 5).

1. A positive resist composition, comprising:
a base resin component (A), which contains acid dissociable, dissolution inhibiting groups and exhibits increased alkali solubility under action of acid; and
an acid generator component (B) that generates acid on irradiation, wherein
said component (A) is a copolymer comprising structural units (a-1), which are derived from an (α-lower alkyl) acrylate ester that contains an acid dissociable, dissolution inhibiting group, and also contains an aliphatic cyclic group, structural units (a-2), which are derived from an (α-lower alkyl) acrylate ester that contain a γ-butyrolactone residue, and structural units (a-3), which are derived from an (α-lower alkyl) acrylate ester that contains a hydroxyl group-containing aliphatic polycyclic hydrocarbon group, and a glass transition temperature (Tg) of said copolymer is within a range from 100 to 170° C.

2. A positive resist composition according to claim 1, wherein a weight average molecular weight of said component (A) is within a range from 4,000 to 8,000.

3. A positive resist composition according to claim 1, wherein said acid dissociable, dissolution inhibiting group is a tertiary alkyl group.

4. A positive resist composition according to claim 3, wherein said structural unit (a-1) is one or more units selected from the group consisting of structural units represented by general formulas (I), (II), and (III) shown below: 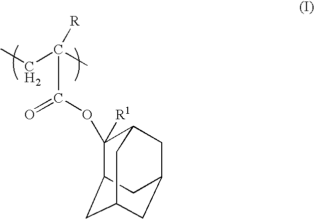
(wherein, R represents a hydrogen atom or a lower alkyl group, and R¹ represents a lower alkyl group), 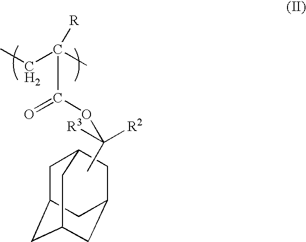
(wherein, R represents a hydrogen atom or a lower alkyl group, and R² and R³ each represent, independently, a lower alkyl group), 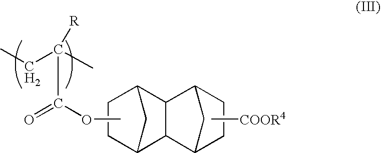
(wherein, R represents a hydrogen atom or a lower alkyl group, and R⁴ represents a tertiary alkyl group).

5. A positive resist composition according to claim 1, wherein said structural unit (a-2) is one or more units selected from the group consisting of structural units represented by a general formula (IV) shown below: 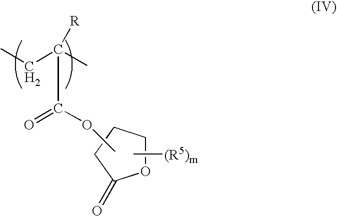
(wherein, R represents a hydrogen atom or a lower alkyl group, R⁵ represents a hydrogen atom or a lower alkyl group, and m represents an integer from 1 to 4).

6. A positive resist composition according to claim 1, wherein said structural unit (a-3) is one or more units selected from the group consisting of structural units represented by a general formula (VI) shown below: 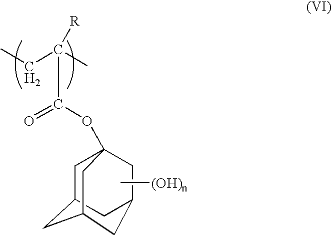
(wherein, R represents a hydrogen atom or a lower alkyl group, and n represents an integer from 1 to 3).

7. A positive resist composition according to claim 1, wherein a proportion of said structural unit (a-1) relative to a combined total of all structural units of said component (A) is within a range from 20 to 60 mol %.

8. A positive resist composition according to claim 1, wherein a proportion of said structural unit (a-2) relative to a combined total of all structural units of said component (A) is within a range from 20 to 60 mol %.

9. A positive resist composition according to claim 1, wherein a proportion of said structural unit (a-3) relative to a combined total of all structural units of said component (A) is within a range from 1 to 30 mol %.

10. A positive resist composition according to claim 1, further comprising: a nitrogen-containing organic compound (C) in a quantity equivalent to 0.01 to 5% by weight relative to said component (A).

11. A method for forming a resist pattern using a lithography process comprising the steps of:
applying a chemically amplified positive resist composition to a substrate to provide a resist film;
conducting selective exposure of said resist film;
performing post exposure baking (PEB); and then
conducting alkali developing, wherein
line and space patterns are first formed at a plurality of preliminary PEB temperatures using said lithography process, a relationship between a size of a space pattern formed and a preliminary PEB temperature at which said size is formed is plotted in a graph with size of said formed space pattern along a vertical axis and said preliminary PEB temperature along a horizontal axis, a preliminary PEB temperature corresponding with a point at which said size reaches a maximum value in said graph is set as an optimum PEB temperature, and a PEB temperature within said lithography process is set to a temperature within ±2° C. of said optimum PEB temperature.

12. A method for forming a resist pattern according to claim 11, wherein a positive resist composition according to any one of claims 1 through 10 is used as said chemically amplified positive resist composition.
